(19) United States
(12) Patent Application Publication
(10) Pub. No.: US 2010/0088542 A1
(43) Pub. Date: Apr. 8, 2010

(54) LOCKUP RECOVERY FOR PROCESSORS

(75) Inventor: Karl F. GREB, Missouri City, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/347,804

(22) Filed: Dec. 31, 2008

Related U.S. Application Data
(60) Provisional application No. 61/103,081, filed on Oct. 6, 2008.

(51) Int. Cl. G06F 11/14

(52) U.S. Cl. 714/10; 714/E11.113

(57) ABSTRACT

A system comprises processing logic configured to assert a lockup signal upon detection of a fault condition and a module coupled to the processing logic and configured to activate a counter upon receiving the lockup signal. After the module activates the counter and before the counter reaches a predetermined threshold, the processing logic attempts to correct the fault condition and the module prevents the processing logic from being reset.

### CROSS-REFERENCE TO RELATED APPLICATIONS

This application claims the benefit of U.S. Provisional Application Ser. No. 61/103,081, filed Oct. 6, 2008, titled “Lockup Recovery for ARMv7M Cores,” and incorporated herein by reference as if reproduced in full below.

### BACKGROUND

Processors often detect faults, or errors in processing, that cause the processors to enter a lockup mode. When in such a lockup mode, the processor generally is unable to process new commands. The processor is programmed to quickly exit this lockup mode by causing an external apparatus to reset the processor to a known state. A reset may cause the processor to lose current execution context data and/or application-critical data. Such data loss is undesirable.

### SUMMARY

The problems noted above are solved in large part by a method and system for processor lockup recovery. Some embodiments include a system that comprises processing logic configured to assert a lockup signal upon detection of a fault condition and a module coupled to the processing logic and configured to activate a counter upon receiving the lockup signal. After the module activates the counter and before the counter reaches a predetermined threshold, the processing logic attempts to correct the fault condition and the module prevents the processing logic from being reset.

Another illustrative embodiment includes a system that comprises means for processing electronic signals and means for receiving a lockup signal from the means for processing. The lockup signal indicates a fault condition on the means for processing. The means for receiving is also for preventing reset of the means for processing during a period of time. During the period of time, the means for processing attempts to clear the fault condition.

Yet another illustrative embodiment includes a method that comprises, as a result of detecting a circuit logic fault condition, measuring a period of time, attempting to correct the fault condition during the period of time, and preventing reset of the circuit logic associated with the fault condition during the period of time. The method further comprises, if the fault condition remains uncorrected by the end of the period of time, then, as a result, resetting the circuit logic.

### BRIEF DESCRIPTION OF THE DRAWINGS

For a detailed description of exemplary embodiments of the invention, reference will now be made to the accompanying drawings in which:

FIG. 1 shows an illustrative block diagram of a system implementing the techniques disclosed herein, in accordance with embodiments;

FIG. 2 shows an illustrative block diagram of a watchdog module and a processing logic subject to the watchdog module, in accordance with preferred embodiments; and

FIG. 3 shows an illustrative flow diagram of a method implemented in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The terms “processor” and “processing logic” are analogous.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein are techniques for permitting a processor that is in a lockup mode to clear any fault(s) responsible for causing the processor to enter the lockup mode. Specifically, a watchdog module determines when an associated processor enters a lockup mode. The watchdog module subsequently begins a countdown for a predetermined length of time. During this window of time, the processor (and any other processors also in lockup mode) is given the opportunity to clear the fault(s) that caused the processor to enter the lockup mode. If, after the predetermined length of time has expired, the processor is still in the lockup mode, the watchdog module resets the processor.

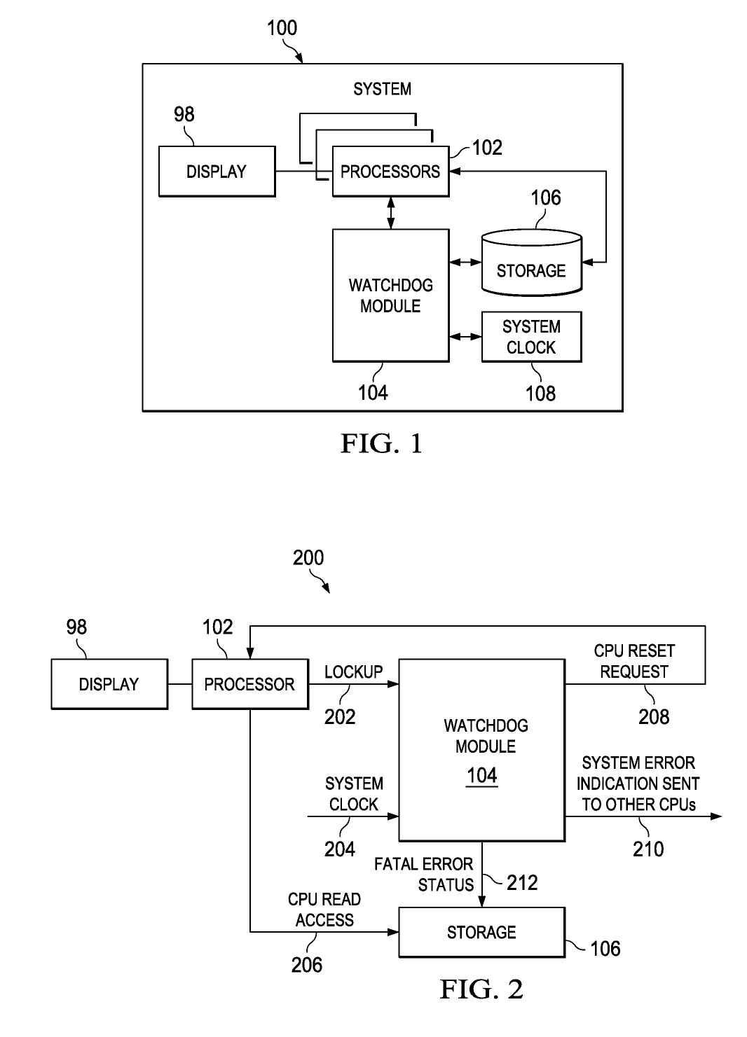

FIG. 1 shows an illustrative block diagram of a system 100 implementing the techniques disclosed herein, in accordance with embodiments. The system 100 may comprise any suitable electronic system, such as an automobile, a mobile communication device, a desktop or notebook computer, a server, a media device, etc. The system 100 includes one or more processors 102. In at least some embodiments, at least one of the processors 102 comprises an ARM v7M processor, although other processors also may be used. In some embodiments, at least some of the processors 102 may be of different types. The processors 102 trade data with a watchdog module 104, the purpose of which is mentioned above and is described in detail below. In turn, the watchdog module 104 couples to a system clock 108 and storage 106. The storage 106 may include random access memory (RAM), read-only memory (ROM), a hard drive, etc. In some embodiments, at least one or more of the processors 102, the watchdog module 104, the storage 106 and the system clock 108 are manufactured on a common electronic chip. The system 100 may also include a display 98 coupled to one or more of the processors 102. In some embodiments, the watchdog module 104 is disposed on the same semiconductor chip as is/are the processor(s) 102.

FIG. 2 shows an illustrative block diagram of a watchdog module and a processor subject to the watchdog module, in accordance with preferred embodiments. Specifically, FIG. 2 shows a subsystem 200, which is part of the system 100 shown in FIG. 1, comprising a processor 102, the watchdog module 104, a LOCKUP signal 202, a system clock signal 204, a CPU read access signal 206, a CPU reset request signal 208, a system error indication signal 210 and a fatal error status signal 212. FIG. 2 differs from FIG. 1 in that FIG. 2 demonstrates the watchdog module's interaction with a single processor 102 for simplicity and clarity of explanation. The interactions described in context of FIG. 2 may be similar to those interactions which take place between the watchdog module 104 and other processors 102.

In operation, the processor 102 may detect or otherwise experience a fault condition. Such a fault condition may arise from, e.g., an error that occurs as a result of executing particular software code. Fault conditions may arise for other reasons as well. A fault condition may compromise system operation. Accordingly, when a fault condition arises, the processor 102 asserts the LOCKUP signal 202.

Upon receiving the asserted LOCKUP signal 202, the watchdog module 104 begins decrementing a counter (e.g., using system clock signal 204, which is received from system clock 108). The watchdog module 104 preferably does not take additional action until the counter has reached a certain threshold. The counter may be pre-set at a predetermined number so that the watchdog module 104 does not take additional action for a predetermined length of time. Thus, for example, the counter may be pre-set at 100, and the watchdog module 104 may not take additional action until the counter has reached 0. In some embodiments, the watchdog module 104 prevents the processor 102 from being reset until the counter has reached 0. In at least some embodiments, the counter may be implemented using a register in storage that is part of the watchdog module 104. Variations of such counter schemes are encompassed within the scope of this disclosure. For instance, in some embodiments, the counter may “count up” to a threshold number instead of “counting down” to 0.

During this window of time in which the counter is being decremented, the processor 102 has the opportunity to clear itself from the fault condition by executing an internal (e.g., stored on the processor 102) LOCKUP software handler routine. Such a routine, when executed by the processor 102, may cause the processor 102 to correct the fault condition that is present on, or being experienced by, the processor 102. In addition, the watchdog module 104 may assert the system error indication signal 210, which is provided to some or all of the other processors in the system. This system error indication signal 210 may cause these other processors to attempt to detect and clear the fault condition and return the processor 102 (shown in FIG. 2) to normal operation.

For example, a fault condition with the processor core 102 shown in FIG. 2 may be resolved by the processor 102 itself. Similarly, the fault condition may be detected and corrected by a different processor 102. In some cases, fault conditions may occur in areas besides processors, such as circuit logic shared among processors and/or memory systems coupled to the processors. Regardless of where the fault condition is to be found or which processor 102 corrects the fault condition, the watchdog module 104 provides the time and the impetus for this correction to occur.

If the fault condition is corrected within the allotted period of time, the processor 102 de-asserts the LOCKUP signal 202. The watchdog module 104 detects that the LOCKUP signal 202 has been de-asserted and, in turn, resets its counter and prevents the CPU reset request signal 208 from being asserted (e.g., disables counting function of the watchdog module 104).

However, if the fault condition is not corrected within the allotted period of time, the watchdog module 104 asserts the CPU reset request signal 208. The CPU reset request signal 208 is provided to the processor 102 and causes the processor 102 to be reset (e.g., a warm reset). In this way, even if the fault condition could not be cleared using a software handler, the fault condition—regardless of whether it is in the processor 102 itself or in circuit logic coupled to the processor 102—is cleared via reset. Preferably no other processors 102 are reset besides the processor(s) associated with the uncorrected fault condition(s). Upon reset, the processor 102 de-asserts the LOCKUP signal 202.

In addition to asserting the CPU reset request signal 208, the watchdog module 104 asserts the fatal error status 212, which causes the storage 106 to accept and store a data read from the processor 102. The data stored in storage 106 enables the storage 106 to reflect that a reset of the processor 102 was performed, the fact that the reset was performed in response to a fault condition and, in some embodiments, the reason why the fault condition occurred. The reason why the fault condition occurred may be ascertainable using the fault condition software handler routine described above. The processor 102 may use this information during future operation to prevent and/or correct similar fault conditions. In some embodiments, the information stored to storage 106 may indicate the amount of time counted prior to reset. If the processor 102 did not clear the fault prior to reset, the watchdog module 104 may increase this amount of time the next time the LOCKUP signal 202 is asserted, thereby giving the processor 102 more time to clear the fault. The amount of time that the watchdog module 104 counts down prior to reset is programmable (e.g., by a user using a graphical user interface (GUI) shown on the display 98). Any type of information may be stored (e.g., program counter value, overall period of time measured/counted, various processor status flags, watchdog module flags and settings, etc.).

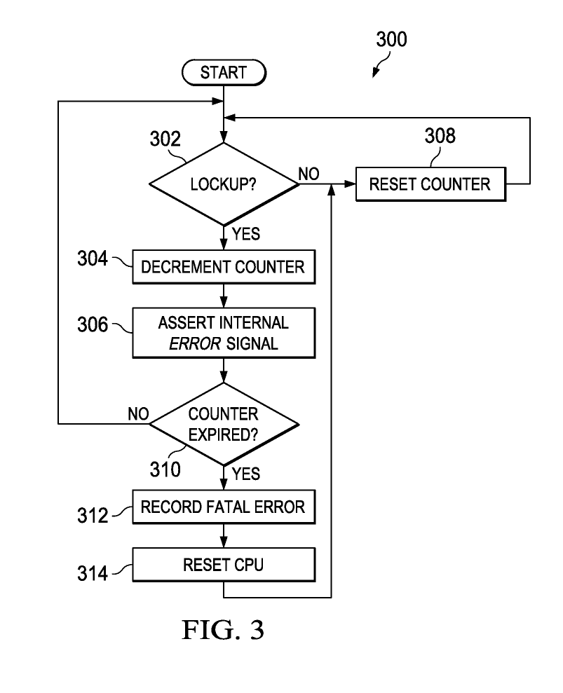

FIG. 3 shows an illustrative flow diagram of a method 300 implemented in accordance with various embodiments. The method 300 begins with the watchdog module 104 determining whether the LOCKUP signal 202 has been asserted (block 302). If not, the method 300 comprises resetting the watchdog module counter (block 308). Otherwise, the method 300 comprises the watchdog module decrementing the counter (block 304) and asserting the system error indication signal 210 (block 306). The method 300 further comprises determining whether the counter has expired (block 310). If not, control of the method 300 passes to block 302. Otherwise, if the counter has expired, the method 300 comprises recording the fatal error in the storage 106 (block 312) and resetting the affected processor or the processor associated with the affected circuit logic (block 314). Control of the method 300 then passes to block 308. The method 300 may be modified by adding or removing steps or by re-arranging steps, as desired.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
processing logic configured to assert a lockup signal upon detection of a fault condition; and
a module coupled to the processing logic and configured to activate a counter upon receiving the lockup signal;
wherein, after the module activates the counter and before the counter reaches a predetermined threshold, the processing logic attempts to correct the fault condition and the module prevents the processing logic from being reset.

2. The system of claim 1, wherein the processing logic attempts to correct the fault condition by executing a lockup software handler routine embedded on the processing logic.

3. The system of claim 1, wherein the module notifies another processing logic about the fault condition and provides the another processing logic with an opportunity to clear the fault condition.

4. The system of claim 1, wherein, if said fault condition is cleared before the counter reaches the predetermined threshold, then, as a result, the module continues to prevent the processing logic from being reset.

5. The system of claim 1, wherein, if said fault condition is not cleared before the counter reaches the predetermined threshold, then, as a result, the module causes the processing logic to be reset.

6. The system of claim 5, wherein the module causes information pertaining to the fault condition to be recorded to storage.

7. The system of claim 1, wherein the system comprises an apparatus selected from the group consisting of an automobile, a mobile communication device, a desktop or notebook computer, a server, and a media device.

8. A system, comprising:
means for processing electronic signals; and
means for receiving a lockup signal from the means for processing, said lockup signal indicates a fault condition on said means for processing;
wherein the means for receiving is also for preventing reset of the means for processing during a period of time;
wherein, during said period of time, the means for processing attempts to clear the fault condition.

9. The system of claim 8, wherein if, during said period of time, the means for processing fails to clear the fault condition, then, as a result, the means for receiving causes the means for processing to be reset.

10. The system of claim 9, wherein the means for receiving causes information pertaining to the fault condition to be stored to means for storing.

11. The system of claim 8, wherein if, during said period of time, the fault condition is cleared, then, as a result, the means for receiving continues to prevent reset of the means for processing.

12. The system of claim 8, wherein the means for processing attempts to clear the fault condition by executing a lockup software handler routine embedded on said means for processing.

13. The system of claim 8, wherein the system comprises an apparatus selected from the group consisting of an automobile, a mobile communication device, a desktop or notebook computer, a server, and a media device.

14. A method, comprising:
as a result of detecting a circuit logic fault condition, measuring a period of time;
attempting to correct the fault condition during said period of time;
preventing reset of said circuit logic associated with the fault condition during said period of time; and
if said fault condition remains uncorrected by the end of said period of time, then, as a result, resetting the circuit logic.

15. The method of claim 14, further comprising, as a result of correcting said fault condition during said period of time, continuing to prevent reset of said circuit logic.

16. The method of claim 14, further comprising, as a result of said fault condition remaining uncorrected, either increasing or decreasing said period of time for a next iteration of said method.

17. The method of claim 14, further comprising storing data pertaining to said fault condition.

18. The method of claim 17, further comprising attempting to correct another fault condition using said stored data.
